(19) United States
(12) Patent Application Publication
(10) Pub. No.: US 2007/0074172 A1
(43) Pub. Date: Mar. 29, 2007

(54) Software problem administration

(75) Inventors: John J. Bird, Rochester, MN (US); Dawn M. May, Mantorville, MN (US); Rose B. Sundermeyer, Kasson, MN (US)

Correspondence Address: IBM (ROC-BLF), C/O BIGGERS & OHANIAN, LLP, P.O. BOX 1469, AUSTIN, TX, 78767-1469, US

(73) Assignee: International Business Machines Corporation, Armonk, NY (US)

(21) Appl. No.: 11/239,618

(22) Filed: Sep. 29, 2005

(51) Int. Cl. G06F 9/44

(52) U.S. Cl. 717/127

(57) ABSTRACT

Methods, systems, and computer program products are provided for software problem administration that includes identifying the occurrence of a predefined watch event; identifying an action in dependence upon the identified predefined watch event and a policy; and executing the action. A policy defines predefined watch events and their associated actions. Identifying the occurrence of a predefined watch event may be carried out by detecting a message of a predefined message type in a message queue. Identifying the occurrence of a predefined watch event may also include detecting a log entry of a predefined log type. Identifying an action in dependence upon the identified predefined watch event and a policy may be carried out by identifying a software upgrade request action and executing the action may be carried out by requesting a software upgrade from a service provider.

### BACKGROUND OF THE INVENTION

1. Field of the Invention

The field of the invention is data processing, or, more specifically, methods, systems, and products for software problem administration.

2. Description Of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Increased sophistication of modern computers has also increased the complexity of detecting, analyzing, and reporting software problems. Some such problems are due to defects in the software, which can be repaired with upgrades or patches. Other problems, however, are due not to defects, but to user errors, install errors, configuration errors, and environmental errors.

Current software solutions for automatically detecting software problems typically require aspects of the software to be instrumented at pre-selected locations to dump predetermined data if a suspected problem is encountered. This requires a programmer to predict what problem may occur, and where and when in the software the problem may occur. Predicting what problem may occur, and where and when in the software the problem may occur is difficult and inflexible. Such current software solutions also do not address other non-defect errors such as user errors, install errors, configuration errors, and environmental errors.

### SUMMARY OF THE INVENTION

Methods, systems, and computer program products are provided for software problem administration that includes identifying the occurrence of a predefined watch event; identifying an action in dependence upon the identified predefined watch event and a policy; and executing the action. A policy defines predefined watch events and their associated actions.

Identifying the occurrence of a predefined watch event may be carried out by detecting a message of a predefined message type in a message queue. Identifying the occurrence of a predefined watch event may also include detecting a log entry of a predefined type.

Identifying an action in dependence upon the identified predefined watch event and a policy may be carried out by identifying a software upgrade request action and executing the action may be carried out by requesting a software upgrade from a service provider.

Identifying an action in dependence upon the identified predefined watch event and a policy may be carried out by identifying a user notification action and executing the action may be carried out by notifying the user of a software problem.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for software problem administration according to embodiments of the present invention.

FIG. 2 sets forth a block diagram of an exemplary system for software problem administration according to embodiments of the present invention.

FIG. 3 sets forth a block diagram of automated computing machinery comprising an exemplary computer useful in software problem administration according to embodiments of the present invention.

FIG. 4 sets forth a flow chart illustrating an exemplary computer-implemented method for software problem administration.

FIG. 5 sets forth a flow chart of an exemplary computer-implemented method for software problem administration that is similar to the method of FIG. 4 but includes a software upgrade request action.

FIG. 6 sets forth a flow chart of an exemplary computer-implemented method for software problem administration that is similar to the method of FIG. 4 and FIG. 5, but that includes a user notification action.

FIG. 7 sets forth a block diagram of a screen shot of an exemplary policy editor useful in creating a policy according to the present invention.

### DETAILED DESCRIPTION OF EXEMPLARY EMBODIMENTS

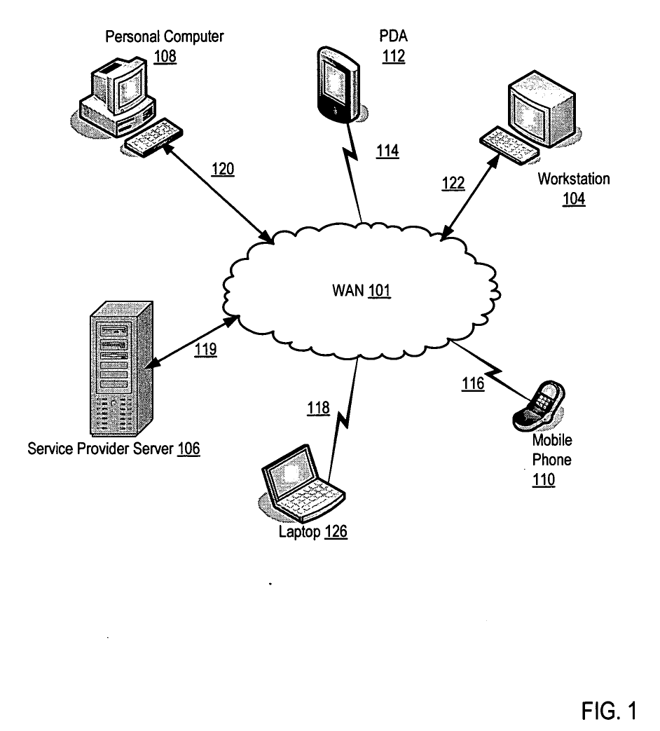

Exemplary methods, systems, and products for software problem administration according to embodiments of the present invention are described with reference to the accompanying drawings, beginning with FIG. 1. FIG. 1 sets forth a network diagram illustrating an exemplary system for software problem administration according to embodiments of the present invention. The system of FIG. 1 includes a number of computers connected for data communications in a wide area network (“WAN”) (101). The network connection aspect of the architecture of FIG. 1 is only for explanation, not for limitation. In fact, systems for software problem administration according to embodiments of the present invention may be connected as LANs, WANs, intranets, internets, the Internet, webs, the World Wide Web itself, or other connections as will occur to those of skill in the art. Such networks are media that may be used to provide data communications connections between various devices and computers connected together within an overall data processing system.

In the example of FIG. 1, a plurality of computers (108, 112, 104, 110, and 126) are connected to the WAN (101). In the example of FIG. 1, a personal computer (108) is connected to the WAN (101) through a wireline connection (120) and a personal digital assistant (‘PDA’) (112) is connected to the WAN (101) through a wireless connection (114). In the example of FIG. 1, a workstation (104) is connected to the WAN (101) through a wireline connection (122), a cellular phone (104) is connected to the WAN (101) through a wireless connection (116), and a laptop computer (126) is connected to the WAN (101) through a wireless connection (118). Each of the computers (108, 112, 104, 110, and 126) of FIG. 1 are capable of software problem administration according to the present invention by identifying the occurrence of a predefined watch event; identifying an action in dependence upon the identified predefined watch event and a policy; and executing the action.

A watch event is a predetermined event that is typically identified by a watch session initiated by a call to a watch Application Programming Interface (‘API’). A watch session implements a programmatic asynchronous method for identifying predefined watch events. Examples of predefined watch events include detecting a message of a predefined message type in a message queue, detecting a log entry of a predefined log type, detecting file changes of interest, detecting requests for a lock, detecting authority changes, identifying software interrupts, identifying hardware interrupts, identifying software execution exceeding predefined thresholds, detecting object changes, detecting program changes, such as a file size change effected by a virus, and any other predefined watch event that will occur to those of skill in the art.

Each of the computers (108, 112, 104, 110, and 126) of FIG. 1 is capable of identifying an action in dependence upon the identified predefined watch event and a policy. A policy implements rules associating predefined watch events and actions. That is, a policy dictates the action to be executed upon identifying the predefined watch event.

An action is software executed in response to the identification of a predefined watch event identified in a policy. Examples of actions include software that, when executed, requests a software upgrade from a service provider, notifies a user of a software problem, modifies a system configuration, creates entries in a problem log, uses analytical tools such as Agent Building and Learning Environment (‘ABLE’) and Artificial Intelligence (‘AI’) facilities to draw inferences regarding the software problem, notifies a service provider of the problem, references customer documentation such as effecting a pointer to a user manual or a help function, provides a user with a description of frequently asked questions, searches a service provider knowledge base, as well as any other action that will occur to those of skill in the art.

In the example of FIG. 1, a server (106) operated by a service provider is connected to the WAN (101) through a wireline connection (119). The server (106) of FIG. 1 is capable of receiving requests for software upgrades from any of the other computers (108, 112, 104, 110, and 126) sent in the execution of an action identified in response to the identification a watch event.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

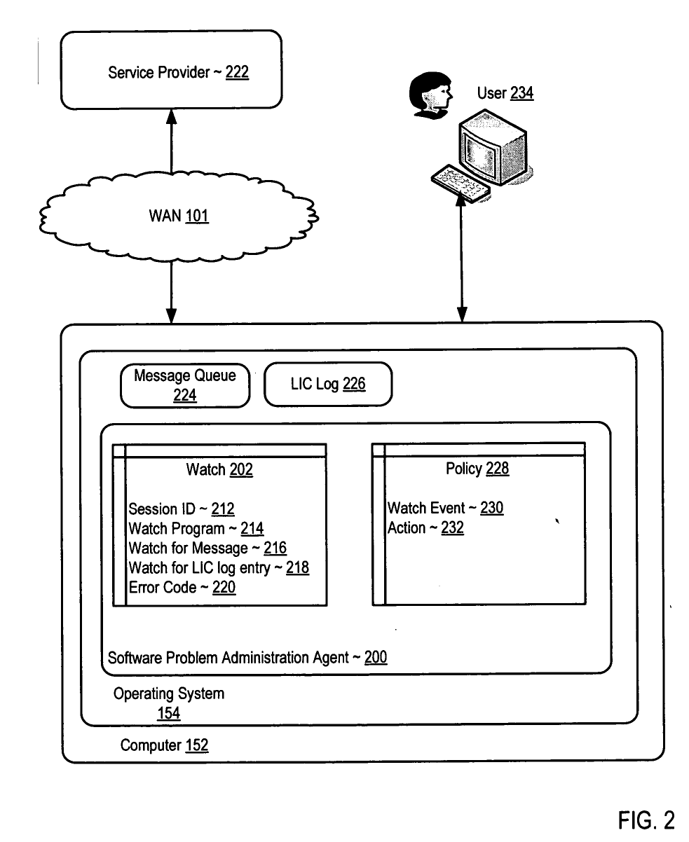

For further explanation, FIG. 2 sets forth a block diagram of an exemplary system for software problem administration according to embodiments of the present invention. The exemplary system of FIG. 2 include a computer (152) having an operating system (154) that includes a software problem administration agent (200), computer program instructions for identifying the occurrence of a predefined watch event, identifying an action in dependence upon the identified predefined watch event and a policy, and executing the action.

As discussed above, a predefined watch event is a predetermined event that is typically identified by a watch session initiated by a call to a watch Application Programming Interface (‘API’). A watch session implements a programmatic asynchronous method for identifying predefined watch events. Examples of predefined watch events include detecting a message of a predefined message type in a message queue, detecting a log entry of a predefined log type, detecting file changes of interest, detecting requests for a lock, detecting authority changes, identifying software interrupts, identifying hardware interrupts, identifying software execution exceeding predefined thresholds, detecting object changes, detecting program changes, such as a file size change effected by a virus, and any other predefined watch event that will occur to those of skill in the art.

The example of FIG. 2 includes a watch session (202) started by a start_watch( ) call to a watch API by the software problem administration agent. The exemplary watch session (202) of FIG. 2 includes a session ID (212) uniquely identifying the watch session. The exemplary watch session (202) of FIG. 2 include a watch program (214) that is a program to be called upon identifying a watch event. The exemplary watch session (202) also includes watch for message (216) identifying a message identifiers to be watched for in a message queue (224). The exemplary watch session (202) also includes watch for LIC log entry (218) identifying a licensed internal code (‘LIC’) log entry to be watched for in a LIC log (226). The exemplary watch session (202) also includes an error code (220) that is a structure in with to return error information.

The software problem administration agent (200) of FIG. 2 identifies an action in dependence upon the identified predefined watch event and a policy (228). A policy implements rules associating predefined watch events and actions. That is, a policy dictates an action for execution upon the identification of the predefined watch events. The policy (228) of the example of FIG. 2 includes one or more watch events (230) and associated actions (232) for execution in response to identifying the watch events.

An action is software executed in response to the identification of a predefined watch event identified in a policy. In the example of FIG. 2, the software problem administration agent is capable of executing actions, such as an action that requests a software upgrade from a service provider (222) and an action that notifies a user (234) of a software problem. Examples of other actions include software that modifies a system configuration, creates entries in a problem log, uses analytical tools such as ABLE and Al facilities to draw inferences regarding the software problem, notifies a service provider of the problem, references customer documentation such as effecting a pointer to a user manual or a help function, provides a user with a description of frequently asked questions, searches a service provider knowledge base, as well as any other action that will occur to those of skill in the art.

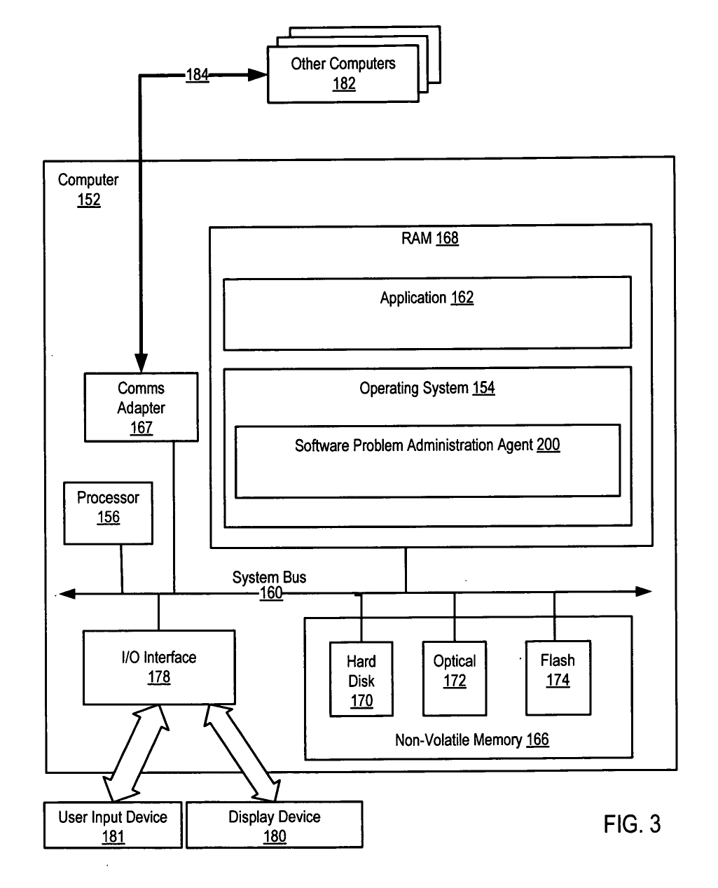

Software problem administration in accordance with the present invention is generally implemented with computers, that is, with automated computing machinery. In the system of FIGS. 1 and 2, for example, all the nodes, servers, and communications devices are implemented to some extent at least as computers. For further explanation, therefore, FIG. 3 sets forth a block diagram of automated computing machinery comprising an exemplary computer (152) useful in software problem administration according to embodiments of the present invention. The computer (152) of FIG. 3 includes at least one computer processor (156) or ‘CPU’ as well as random access memory (168) (‘RAM’) which is connected through a system bus (160) to processor (156) and to other components of the computer.

Stored in RAM (168) is an operating system (154). Operating systems useful in computers according to embodiments of the present invention include UNIX™, Linux™, Microsoft Windows XP™, AIX™, IBM's i5/OS™, and others as will occur to those of skill in the art. The operating system (154) includes a Software Problem Administration Agent (200), computer program instructions for identifying the occurrence of a predefined watch event, identifying an action in dependence upon the identified predefined watch event and a policy, and executing the action.

Stored in RAM (168) is an application (162). Such application may generate predetermined watch events identified by the software problem administration agent in software problem administration according to the present invention. Operating system (154), software problem administration agent (200), and application (162) in the example of FIG. 3 are shown in RAM (168), but many components of such software typically are stored in non-volatile memory (166) also.

Computer (152) of FIG. 3 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 3 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 3 includes a communications adapter (167) for implementing data communications (184) with other computers (182). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for determining availability of a destination according to embodiments of the present invention include modems for wired dial-up communications, Ethernet (IEEE 802.3) adapters for wired network communications, and 802.11b adapters for wireless network communications.

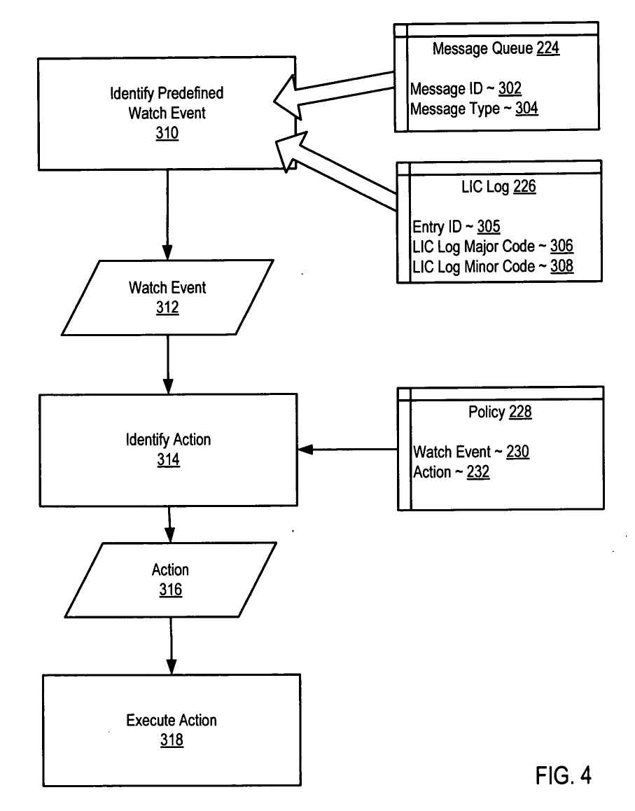

For further explanation, FIG. 4 sets forth a flow chart illustrating an exemplary computer-implemented method for software problem administration. The method of FIG. 4 includes identifying (310) the occurrence of a predefined watch event (312). The example of FIG. 4 illustrates two ways of identifying (310) the occurrence of a predefined watch event (312). Identifying (310) the occurrence of a predefined watch event (312) according to the method of FIG. 4 may be carried out by detecting a message (302) of a predefined message type (304) in a message queue (224). Detecting a message (302) of a predefined message type (304) in a message queue (224) may be carried out by a watch session started by a start_watch( ) call to a watch API by a software problem administration agent.

Identifying (310) the occurrence of a predefined watch event (312) according to the method of FIG. 4 also may be carried out by detecting a log entry (305) of a predefined type. In the example of FIG. 4 a LIC log (226) includes entries having an entry ID (305) uniquely identifying the LIC log entry and an LIC log major code (306) and an LIC minor code (308) that are used as identifiers for detecting a log entry of a predefined type to identity the occurrence of a predefined watch event. Detecting a log entry (305) of a predefined type (306 and 308) may be carried out by a watch session started by a start_watch( ) call to a watch API by a software problem administration agent.

The method of FIG. 4 also includes identifying (314) an action (316) in dependence upon the identified predefined watch event (312) and a policy (228), and executing (318) the action. As discussed above, a policy implements rules associating predefined watch events and actions. That is, a policy dictates an action for execution upon the identification of the predefined watch events. The policy (228) of the example of FIG. 4 includes one or more watch events (230) and associated actions (232) for execution in response to identifying the watch events.

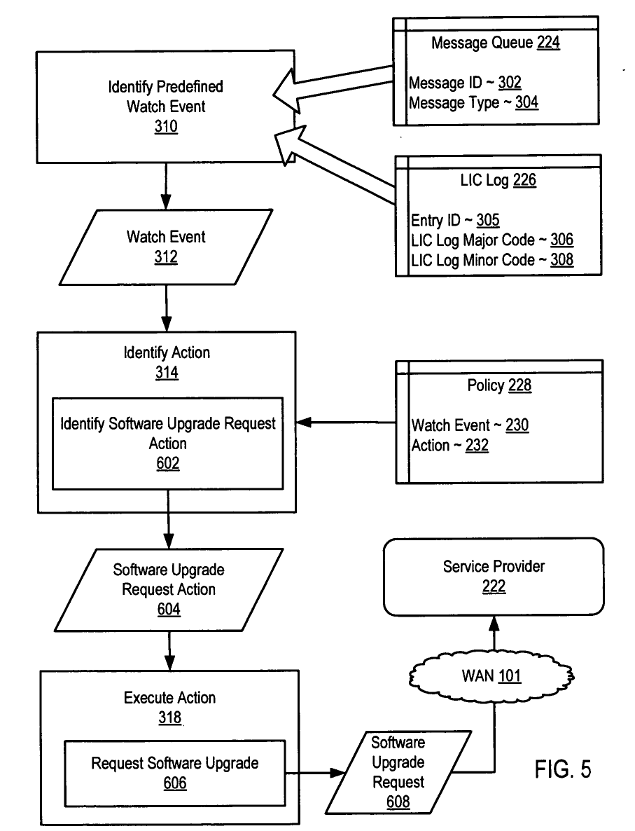

As discussed above, an action (316) is software executed in response to the identification of a predefined watch event identified in a policy. One example of an action useful in software problem administration according to the present invention includes a software upgrade request action. For further explanation, FIG. 5 sets forth a flow chart of an exemplary computer-implemented method for software problem administration that is similar to the method of FIG. 4 but includes a software upgrade request action. That is, the method for software problem administration of FIG. 5 includes identifying (310) the occurrence of a predefined watch event (312); identifying (314) an action in dependence upon the identified predefined watch event (312) and a policy (228); and executing (318) the action. In the example of FIG. 5, however, identifying (314) an action in dependence upon the identified predefined watch event (312) and a policy (228) is carried out by identifying (602) a software upgrade request action (604). A software upgrade request action is software that when executed request an upgrade from a service provider.

In the method of FIG. 5, executing (318) the action is carried out by requesting (606) a software upgrade from a service provider (222). Requesting (606) a software upgrade from a service provider (222) may be carried out by sending a request (608) to a service provider (222) at a network location requesting an upgrade and identifying the software for which the upgrade is intended.

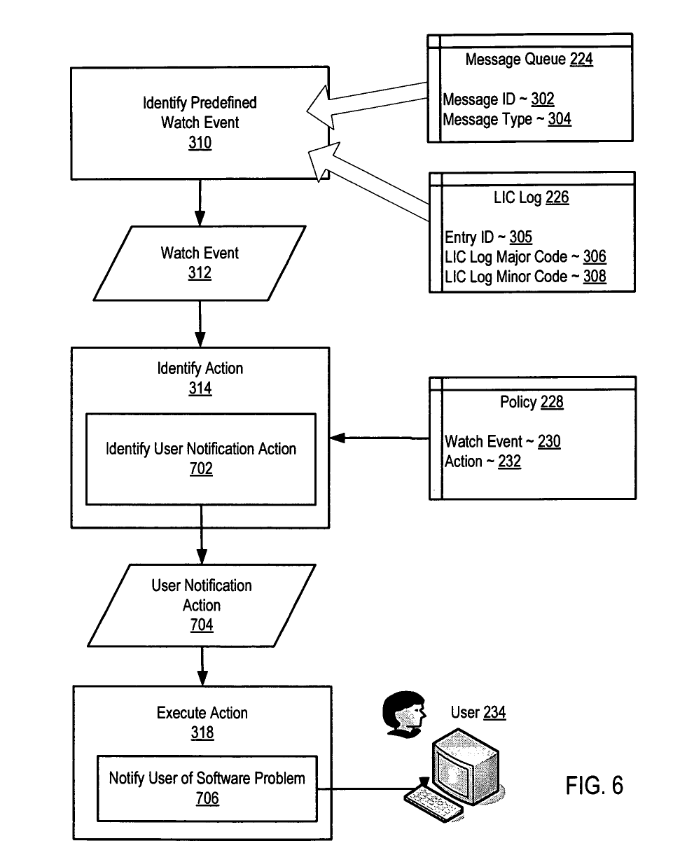

Another example of an action useful in software problem administration according to the present invention includes a user notification action. For further explanation, FIG. 6 sets forth a flow chart of an exemplary computer-implemented method for software problem administration that is similar to the method of FIG. 4 and FIG. 5, but that includes a user notification action. That is, the method for software problem administration of FIG. 6 includes identifying (310) the occurrence of a predefined watch event (312); identifying (314) an action in dependence upon the identified predefined watch event (312) and a policy (228); and executing (318) the action. In the method of FIG. 6, however, identifying (314) an action in dependence upon the identified predefined watch event (312) and a policy (228) is carried out by identifying (702) a user notification action (704). A user notification action is software that when executed sends a notification to a user identifying the software problem.

In the method of FIG. 6, executing (318) the action is carried out by notifying (706) the user (234) of a software problem. Notifying (706) the user (234) of a software problem may be carried out by sending a system administrator an automated email describing the software problem.

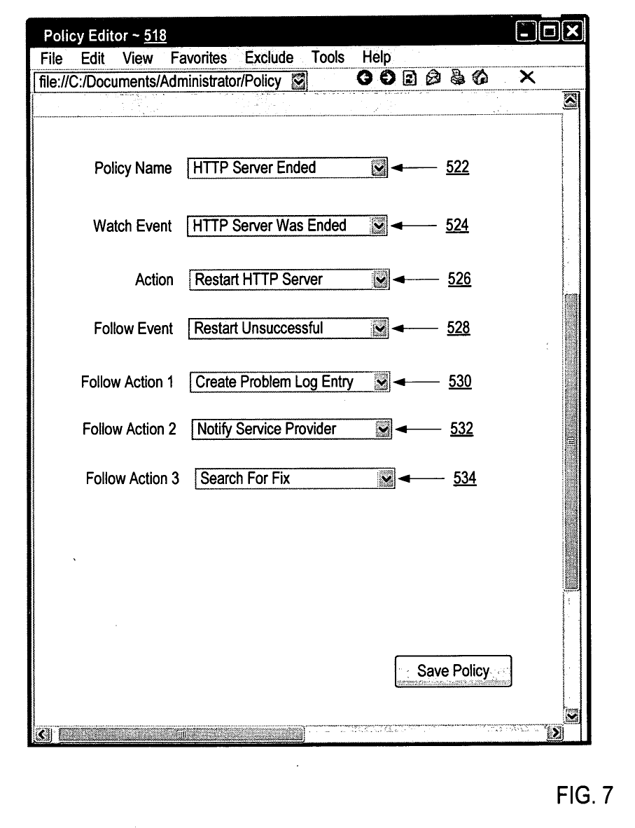

As discussed above, software problem administration according to the present invention usefully uses policies. Software problem administration according to the present invention therefore typically also includes creating a policy by receiving one or more identifications of predefined watch events and associating one or more actions with the predefined watch events. For further explanation, FIG. 7 sets forth a block diagram of a screen shot of an exemplary policy editor (518) useful in creating a policy according to the present invention. The exemplary policy editor (518) of FIG. 7 includes a GUI text box (522) for receiving a policy name identifying the policy being created. In the example of FIG. 7, the current policy being created is named ‘HTTP Server Ended.’

The exemplary policy editor (518) of FIG. 7 includes a GUI text box (524) for receiving a watch event for the policy. In the example of FIG. 7, the selected watch event is ‘HTTP Server Was Ended.’

The exemplary policy editor (518) of FIG. 7 includes a GUI text box (526) for receiving an action identified in response to identifying the watch event is ‘HTTP Server Was Ended.’ In the example of FIG. 7, the selected action is entitled ‘Restart HTTP Server’ that, when executed, restarts the HTTP server.

The exemplary policy editor (518) of FIG. 7 includes a GUI text box (528) for receiving a follow event. A follow event is another watch event that if detected after the execution of the action, in this case ‘Restart HTTP Server,’ gives rise to additional follow actions. In the example of FIG. 7, the selected follow event (528) is entitled ‘Restart Unsuccessful’ identifying a watch event as the unsuccessful restart of the HTTP server.

The exemplary policy editor (518) of FIG. 7 includes five GUI text boxes (530, 532, and 534) for receiving follow actions. Follow actions are actions executed in response to the identification of the follow event (528). The exemplary policy editor (518) of FIG. 7 includes a GUI text box (530) for receiving an identification of a follow action. In the example of FIG. 7, the follow action ‘Create Problem Log Entry’ is selected that, when executed, creates a log entry for the software problem in a software problem log.

The exemplary policy editor (518) of FIG. 7 includes a GUI text box (532) for receiving an identification of another follow action. In the example of FIG. 7, the follow action ‘Notify Service Provider’ is selected that, when executed, notifies a service provider identified for the HTTP server.

The exemplary policy editor (518) of FIG. 7 includes a GUI text box (534) for receiving an identification of another follow action. In the example of FIG. 7, the follow action ‘Search For Fix’ is selected that, when executed, uses a predetermined search function to search for a fix, and upon finding a fix, downloads and applies the fix.

In the example of FIG. 7, the policy named ‘HTTP Server Ended’ defines that when a predefined watch event for the HTTP server ends an associated action is executed to restart the HTTP server. If the HTTP server restarts, no follow actions are executed. If the HTTP server restart is unsuccessful, the three follow actions are executed to create a log entry in a problem log, notify a service provider for the HTFP server, and search for a fix, and if found, download and install the fix.

Exemplary embodiments of the present invention are described largely in the context of a fully functional computer system for software problem administration. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A computer-implemented method for software problem administration, the method comprising:
identifying the occurrence of a predefined watch event;
identifying an action in dependence upon the identified predefined watch event and a policy; and
executing the action.

2. The method of claim 1 wherein identifying the occurrence of a predefined watch event further comprises detecting a message of a predefined message type in a message queue.

3. The method of claim 1 wherein identifying the occurrence of a predefined watch event further comprises detecting a log entry of a predefined type.

4. The method of claim 1 wherein:
identifying an action in dependence upon the identified predefined watch event and a policy further comprises identifying a software upgrade request action; and
executing the action further comprises requesting a software upgrade from a service provider.

5. The method of claim 1 wherein:
identifying an action in dependence upon the identified predefined watch event and a policy further comprises identifying a user notification action; and
executing the action further comprises notifying the user of a software problem.

6. The method of claim 1 wherein a policy defines predefined watch events and their associated actions.

7. The method of claim 1 further comprising creating a policy including
receiving an identification of a predefined watch event and associating an action with the predefined watch event.

8. A system for software problem administration, the system comprising:
a computer processor;
a computer memory operatively coupled to the computer processor, the computer memory having disposed within it computer program instructions capable of:
identifying the occurrence of a predefined watch event;
identifying an action in dependence upon the identified predefined watch event and a policy; and
executing the action.

9. The system of claim 8 wherein the computer memory also has disposed within it computer program instructions capable of detecting a message of a predefined message type in a message queue.

10. The system of claim 8 wherein the computer memory also has disposed within it computer program instructions capable of detecting a log entry of a predefined type.

11. The system of claim 8 wherein the computer memory also has disposed within it computer program instructions capable of:
identifying a software upgrade request action; and
requesting a software upgrade from a service provider.

12. The system of claim 8 wherein the computer memory also has disposed within it computer program instructions capable of:
identifying a user notification action; and
notifying the user of a software problem.

13. The system of claim 8 wherein a policy defines predefined watch events and their associated actions.

14. The system of claim 8 wherein the computer memory also has disposed within it computer program instructions capable of creating a policy including receiving an identification of a predefined watch event and associating an action with the predefined watch event.

15. A computer-implemented computer program product for software problem administration, the computer program product disposed upon a signal bearing medium, the computer program product comprising
computer program instructions for identifying the occurrence of a predefined watch event;
computer program instructions for identifying an action in dependence upon the identified predefined watch event and a policy; and
computer program instructions for executing the action.

16. The computer program product of claim 15 wherein computer program instructions for identifying the occurrence of a predefined watch event further comprise computer program instructions for detecting a message of a predefined message type in a message queue.

17. The computer program product of claim 15 wherein computer program instructions for identifying the occurrence of a predefined watch event further comprise computer program instructions for detecting a log entry of a predefined type.

18. The computer program product of claim 15 wherein:
computer program instructions for identifying an action in dependence upon the identified predefined watch event and a policy further comprise computer program instructions for identifying a software upgrade request action; and
computer program instructions for executing the action further comprise computer program instructions for requesting a software upgrade from a service provider.

19. The computer program product of claim 15 wherein:
computer program instructions for identifying an action in dependence upon the identified predefined watch event and a policy further comprise computer program instructions for identifying a user notification action; and
computer program instructions for executing the action further comprise computer program instructions for notifying the user of a software problem.

20. The computer program product of claim 15 wherein a policy defines predefined watch events and their associated actions.

21. The computer program product of claim 15 further comprising creating a policy including receiving an identification of a predefined watch event and associating an action with the predefined watch event.

22. The computer program product of claim 15 wherein the signal bearing medium comprises a recording medium.

23. The computer program product of claim 15 wherein the signal bearing medium comprises a transmission medium.
